(19) United States
(12) Patent Application Publication
(10) Pub. No.: US 2020/0106332 A1
(43) Pub. Date: Apr. 2, 2020

(54) MOTOR AND DISK DRIVE

(71) Applicant: Nidec Corporation, Kyoto (JP)

(72) Inventor: Takuro IGUCHI, Kyoto (JP)

(21) Appl. No.: 16/513,830

(22) Filed: Jul. 17, 2019

(30) Foreign Application Priority Data
Sep. 27, 2018 (JP) 2018-181409

(51) Int. Cl. H02K 7/00; H02K 5/16; H02K 7/08; G11B 5/09

(52) U.S. Cl. CPC H02K 7/003; G11B 5/09; H02K 7/088; H02K 5/165

(57) ABSTRACT

A motor for a disk drive includes a stationary unit, a bearing mechanism attached to the stationary unit, and a rotation unit supported on the stationary unit rotatably around a central axis via the bearing mechanism. The stationary unit includes a base portion that is a part of a housing defining an internal space sealed in the disk drive and includes a recess portion recessed from a side of the internal space toward an outside of the housing and not penetrated. The bearing mechanism includes a shaft extending in a direction of the central axis and a sleeve surrounding at least a portion of an outer circumferential surface of the shaft. A lower end portion of the shaft is press-fit and glued into the recess portion, and a lower surface of the base portion including a base step portion extending toward an axially upper side.

### CROSS REFERENCE TO RELATED APPLICATION

The present disclosure claims priority under 35 U.S.C. § 119 to Japanese Application No. 2018-181409 filed on Sep. 27, 2018, the entire contents of which are hereby incorporated herein by reference.

### 1. FIELD OF THE INVENTION

The present disclosure relates to a motor and a disk drive.

### 2. BACKGROUND

A housing of a conventional hard disk drive is required to have extremely high airtightness in order to keep an internal space clean. Thus, when an inside of the housing is to be filled with low-density gas such as helium, the extreme high airtightness is required. A motor in which a recess portion not penetrating to an outside of a disk drive is provided on a base plate and a shaft is fixed to the recess portion, in order to prevent helium gas from flowing out to the outside of the disk drive.

In the case of the conventional motor described above, in a process of press-fitting the shaft into the base plate, one end of the shaft must be grasped by a jig. When the shaft is press-fitted into the base plate in a state where the one end of the shaft is grasped by the jig, there is a risk that the shaft may be inclined and press-fitted into the base plate.

### SUMMARY

According to an example embodiment of the present disclosure, a motor for a disk drive includes a stationary unit, a bearing mechanism attached to the stationary unit, and a rotation unit supported on the stationary unit rotatably around a central axis via the bearing mechanism. The stationary unit includes a base portion. The base portion is a part of a housing defining an internal space sealed in the disk drive. The base portion includes a recess portion that is recessed from a side of the internal space toward an outside of the housing and that is not penetrated. The bearing mechanism includes a shaft extending in a direction of the central axis and a sleeve surrounding at least a portion of an outer circumferential surface of the shaft. A lower end portion of the shaft is press-fit and glued into the recess portion. A lower surface of the base portion includes a base step portion extending toward an axially upper side.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a sectional view of a disk drive according to a first example embodiment of the present disclosure.

FIG. 2 is an enlarged sectional view of a portion of a motor of FIG. 1.

FIG. 3 is a view illustrating a portion of the motor during assembly.

FIG. 4 is a diagram illustrating a flow of assembling of the motor.

### DETAILED DESCRIPTION

Example embodiments of the present disclosure will be described hereinafter with reference to the drawings. In the present disclosure, a direction parallel to a central axis of a motor is referred to as an “axial direction”, a direction orthogonal to the central axis of the motor is referred to as a “radial direction”, and a direction along an arc around the central axis of the motor is referred to as a “circumferential direction”. In the present disclosure, the axial direction is also referred to as a vertical direction and a side of a stator unit is referred to as an upper with respect to a base portion to describe a shape or a positional relationship of each part. It should be noted that directions of the motor and a disk drive according to the present disclosure at a time when they are used are not intended to be limited by the definition of the vertical direction described above.

In addition, “parallel direction” in the present disclosure includes a substantially parallel direction. Further, “orthogonal direction” in the present disclosure includes a substantially orthogonal direction.

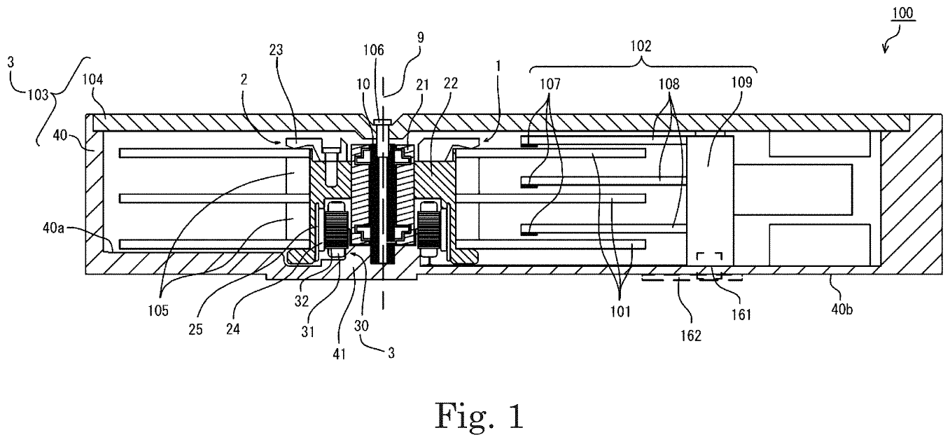

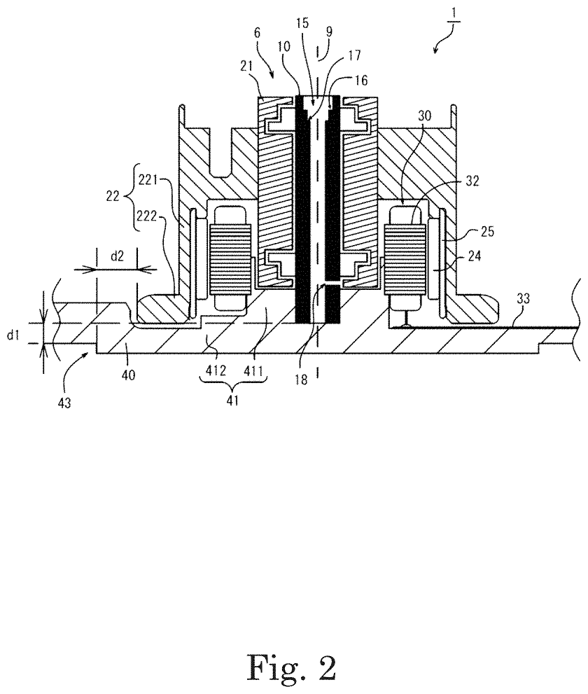

FIG. 1 is a sectional view of a disk drive 100 according to the first example embodiment of the present disclosure. FIG. 2 is an enlarged sectional view of a part of a motor 1 of FIG. 1.

The disk drive 100 is a hard disk drive. The disk drive 100 includes the motor 1, a plurality of (three in FIG. 1) disks 101, an access unit 102, and a housing 103 for accommodating these.

The housing 103 has a base portion 40 and a cover member 104. The base portion 40 is also a part of the motor 1 described later. The base portion 40 has an opening, and the cover member 104 is fitted in the opening to constitute the housing 103. In an internal space of the housing 103, a shaft 10, a rotation unit 2, and a stator unit 30 of the motor 1 described later are accommodated. The base portion 40 and the cover member 104 are combined such that airtightness in the housing 103 is not impaired. The internal space of the housing 103 is filled with gas having a density lower than that of air, for example, helium gas. The internal space of the housing 103 may be filled with hydrogen gas, air, or the like.

As shown by a broken line in FIG. 1, one through hole 161 is provided in the base portion 40, and an external circuit 162 is provided on a lower surface of the base portion 40 so as to cover the through hole 161. A connector is arranged in the through hole 161 and the through hole 161 is sealed by a means such as an adhesive. The connector is connected to the external circuit 162 located outside the housing 103.

The plurality of disks 101 are media on which information is recorded. A spacer 105 is arranged between the disks 101 adjacent to each other and the disks 101 are layered along a central axis 9 vertically extending. The plurality of disks 101 are supported by the motor 1 described later in detail. The plurality of disks 101 are rotated around the central axis 9 by the motor 1.

The access unit 102 includes heads 107, arms 108, and a head moving mechanism 109. Each of the heads 107 approaches a surface of the disk 101 and magnetically performs at least one of reading of the information recorded on the disk 101 and writing the information on the disk 101. Each head 107 is supported by the arm 108. The arms 108 are supported by the head moving mechanism 109.

The motor 1 has the shaft 10, the rotation unit 2, the stator unit 30, the base portion 40, and wirings 33. The motor 1 according to the example embodiment of the present disclosure is a three-phase motor. The stator unit 30 and the housing 103 including the base portion 40 constitute a “stationary unit 3” according to the example embodiment of the present disclosure.

The shaft 10 is a cylindrical member having a hollow portion 15 extending along the central axis 9. On an axially upper side of the hollow portion 15, an inner circumferential surface of the shaft 10 is provided with a shaft step portion 16 that expands radially outside. The shaft step portion 16 is also a portion to which a jig J1 described later is attached. A fixed step portion 17 that is continuous with the shaft step portion 16 is provided on an axially lower side of the shaft step portion 16. As shown in FIG. 1, when a screw 106 is inserted from an upper side of the cover member 104 of the housing 103, an upper end portion of the shaft 10 is screwed with the cover member 104 at the fixed step portion 17.

The shaft 10 has an insertion hole 18 penetrating radially outside from the inner circumferential surface toward an outer circumferential surface of the shaft 10 at the axially lower side of the hollow portion 15. The insertion hole 18 has a function of releasing the air between a lower end portion of the shaft 10 and the base portion 40 to an outside of a bearing mechanism 6 described later via the hollow portion 15. As a result, work efficiency for fixing the lower end portion of the shaft 10 to the base portion 40 is improved. The shaft 10 supports the rotation unit 2 rotatably around the central axis 9. The shaft 10 is formed of, for example, a metal such as stainless steel.

The rotation unit 2 includes a sleeve 21, a rotor hub 22, a clamp member 23, a magnet 24, and a yoke 25.

The sleeve 21 is rotatably supported around the central axis 9. The sleeve 21 is opposite to the shaft 10 via a gap around the shaft 10. The gap is filled with a fluid such as lubricating oil or gas. In the example embodiment of the present disclosure, the bearing mechanism 6 is composed of the outer circumferential surface of the shaft 10, an inner circumferential surface of the sleeve 21, and the fluid interposed between them.

The rotor hub 22 is cylindrical. The rotor hub 22 has a side wall part 221 that covers a radial outside of the magnet 24 via the yoke 25 and a flange part 222 that extends radially outside from an axially lower end of the side wall part 221. The rotor hub 22 is supported by the sleeve 21. The rotor hub 22 rotates together with the sleeve 21 around the central axis 9. The sleeve 21 and the rotor hub 22 may be formed of a single member or may be separate members. For material of the sleeve 21 and the rotor hub 22, for example, a metal such as an aluminum alloy or ferromagnetic stainless steel is used.

The clamp member 23 is supported by the rotor hub 22. The clamp member 23 supports the plurality of disks 101 with the rotor hub 22. Thus, the plurality of disks 101 are supported by the rotation unit 2 and rotate around the central axis 9. The lowermost disk 101 in the plurality of disks 101 is supported by the flange part 222 of the rotor hub 22.

The magnet 24 is fixed to an inner circumferential surface of the rotor hub 22 via the yoke 25. The magnet 24 has an annular shape centered on the central axis 9. An inner circumferential surface of the magnet 24 is a magnetic pole surface in which N and S poles are alternately arranged along the circumferential direction.

The stator unit 30 is arranged in a radial inside of the rotor hub 22 and is opposite to the magnet 24 with a gap. The stator unit 30 generates a torque for rotating the rotation unit 2. The stator unit 30 includes a plurality of coils 31 and a stator core 32. The stator core 32 is a layered structure in which a plurality of annular magnetic bodies centered on the central axis 9 are layered, and is fixed to the base portion 40. The stator core 32 has a plurality of teeth projecting radially outside. The plurality of coils 31 are wound around the plurality of teeth respectively and arranged annularly around the central axis 9. The plurality of coils 31 are constituted with coil groups composed of three phases of U-phase, V-phase and W-phase, and each coil group has one wiring 33 from each phase. Each coil group is composed of one conducting wire.

The base portion 40 is molded by casting, for example.

The base portion 40 is an aluminum die-cast. The base portion 40 has an upper surface 40a and a lower surface 40b. The upper surface 40a is a surface facing an inside of the housing 103. The lower surface 40b is a surface facing an outside of the housing 103. The base portion 40 has a recess portion 401 not penetrating to the outside of the housing 103 on a side of an internal space of the housing 103. Specifically, the base portion 40 is a part of the housing 103 that forms the sealed internal space in the disk drive 100, and has the recess portion 401 that is dented from the side of the internal space toward the outside of the housing 103 and that is not penetrated. The lower end portion of the shaft 10 is fixed in the recess portion 401 by gluing and press-fitting. A thermosetting adhesive 7 is used for adhesion.

The base portion 40 has a protrusion part 41 that protrudes to an upper side from the upper surface 40a. The protrusion part 41 has a first protrusion 411 and a second protrusion 412. The first protrusion 411 fixes the shaft 10 on the outer circumferential surface of the shaft 10. In other words, the recess portion 401 is located inside the first protrusion 411. The first protrusion 411 supports the stator core 32 of the stator unit 30 on an outer circumferential surface thereof. The second protrusion 412 is provided on the outer circumferential surface of the first protrusion 411. The second protrusion 412 has a lower height in the vertical direction than that of the first protrusion 411. The stator unit 30 supported by the first protrusion 411 is arranged above the second protrusion 412.

The lower surface 40b of the base portion 40 has a base step portion 43 dented to the axially upper side. As shown in FIG. 2, the base step portion 43 is located at the axially lower side than the lower end portion of the shaft 10 by a distance d1. A jig J1 described later is located at the shaft step portion 16. A chuck J2 described later is located at the base step portion 43. The shaft step portion 16 and the base step portion 43 become force points when an inclination of the shaft 10 with respect to the central axis 9 is corrected. On the other hand, the lower end portion of the shaft 10 becomes a point of action directly linked to correcting the inclination of the shaft 10 with respect to the central axis 9. For example, when the base step portion 43 is located at the axially upper side than the lower end of the shaft 10, the shaft step portion 16, the base step portion 43, and the lower end portion of the shaft 10 are arranged from the upper side in the axial direction. In the axial direction, since the lower end portion of the shaft 10, that is the point of action, is not sandwiched by the force points, it is difficult to accurately correct the inclination of the shaft 10 with respect to the central axis. In the present example embodiment, since the base step portion 43 is located at the axially lower side than the lower end portion of the shaft 10, the shaft step portion 16, the lower end portion of the shaft 10, and the base step portion 43 are arranged from the upper side in the axial direction. That is, in the axial direction, since the lower end portion of the shaft 10, that is the point of action, is sandwiched by the force points, the inclination of the shaft 10 with respect to the central axis 9 is accurately correctable.

As shown in FIG. 2, the base step portion 43 is located at the radially outer side than a radially outer end of the rotation unit 2 by a distance d2. Compared with a case where the base step portion 43 is located at the radially inner side than the radially outer end of the rotation unit 2, in the present example embodiment, a radial interval at which the base step portion 43 is grasped by the chuck J2 described later is wide. Thus, the base portion 40 is stably grasped, and the inclination of the shaft 10 with respect to the central axis 9 is accurately correctable.

The wirings 33 extend from the coils 31 of the stator unit 30, and are arranged along the upper surface 40a of the base portion 40, that is, a surface of the housing 103 on a side of the internal space shown in FIG. 1. The wirings 33 extend from the coils 31 toward the through hole 161 in which the connector is arranged. The connector is connected to the external circuit 162 located outside the housing 103. Each wiring 33 is an FPC (flexible printed circuit board) as an example.

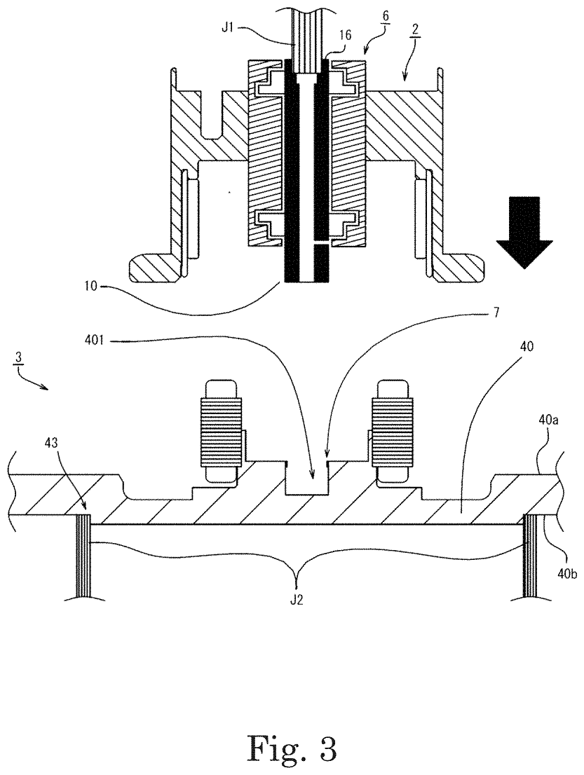

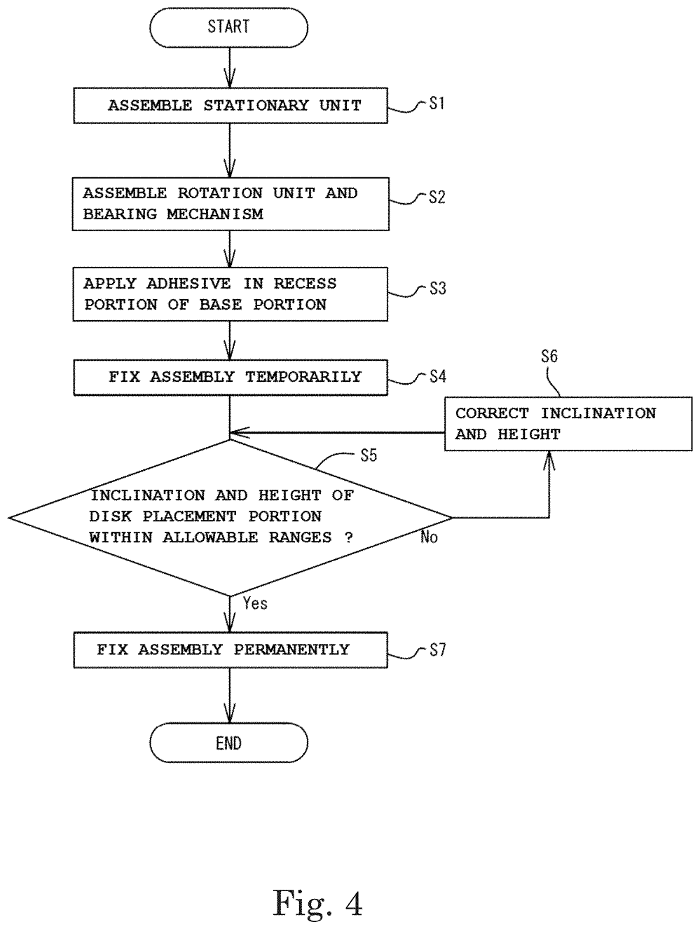

FIG. 3 is a view illustrating a part of the motor 1 during assembly. FIG. 4 is a diagram illustrating a flow of the assembling of the motor 1. The assembling of the motor 1 will be described hereinafter with reference to FIG. 1 to FIG. 4.

FIG. 4 is a diagram illustrating the flow of the assembling of the motor 1. At first, the stationary unit 3 is assembled (step S1). Subsequently, the rotation unit 2 and the bearing mechanism 6 are assembled as one assembly (step S2). Assembling of the stationary unit 3 may be performed after or in parallel with the assembling of the assembly. Subsequently, a thermosetting adhesive 7 is applied in the vicinity of an opening of an inside surface of the recess portion 401 of the base portion (step S3). Then, the shaft 10 is press-fitted into the recess portion 401, whereby the bearing mechanism 6 is temporarily fixed to the base portion 40 (step S4). In step S4, at first, the jig J1 included in a movement mechanism not shown is inserted from the axially upper side into the shaft step portion 16 of the shaft 10, and the base step portion 43 of the base portion 40 is grasped from the axially lower side by the chuck J2 included in a movement mechanism not shown. As compared with a case where no mechanism for supporting the base portion 40 is provided, even if the shaft 10 is inclined from the central axis 9 and is press-fitted, the inclination of the shaft 10 is correctable by moving the chuck J2 grasping the base step portion 43 in a lateral direction by a distance necessary for correcting the inclination of the shaft 10.

Subsequently, in a state where the bearing mechanism 6 is temporarily fixed to the stationary unit 3, the inclination and a height of the flange part 222 of the rotation unit 3 are measured with reference to the base portion 40. Measurement of the inclination of the flange part 222 supporting the plurality of disks 101 corresponds to measurement of perpendicularity of the shaft 10 with respect to the base portion 40.

Subsequently, it is determined whether the inclination and the height of the flange part 222 are within respective allowable ranges, that is, whether the perpendicularity of the shaft 10 and the height of the lower end portion of the shaft 10 are within the allowable ranges (step S5). When they are within the allowable ranges, the stationary unit 3 and the assembly are heated and the adhesive 7 is cured. The shaft 10 is permanently fixed to the recess portion 401 by a cure of the adhesive 7 (step S7). The fastening strength between the assembly and the base portion 40 is sufficiently securable.

When the inclination or the height of the flange part 222 is out of the allowable range, that is, the perpendicularity or the axial position of the shaft 10 is out of the allowable range, the inclination and the height of the flange part 222 are corrected to be within the allowable ranges with respect to the base portion 40 (step S6). As a result, the perpendicularity and the axial position of the shaft 10 are corrected. When it is confirmed by the measurement again that the inclination and the height of the flange part 222 are within the allowable ranges (step S5), the base portion 40 is heated by a heating unit not shown. By the cure of the adhesive 7, the bearing mechanism 6 is permanently fixed (step S7). By the above flow, an assembling operation of the motor 1 is completed.

The structure and the assembling operation of the motor 1 according to the first example embodiment have been described above. The disk drive 1 is preferably filled with the helium gas having very small molecules and a large diffusion coefficient. Thus, in a case of a motor in which the shaft is fixed to a through hole provided in the base portion, it is not easy to secure sufficient sealability between the through hole and the shaft. In the motor 1, since the shaft 10 is fixed to the recess portion 401 of the base portion 40, that is, the non-penetrating hole portion, the helium gas is prevented from flowing out. By sealing the helium gas, reliability and durability of the disk drive 1 are improvable.

In the bearing mechanism 6, when the shaft 10 is press-fitted into the recess portion 401, the air in a space surrounded by the shaft 10 and the recess portion 401 is discharged through the hollow portion 15 and the insertion hole 18 of the shaft 10, so that a pressure in the above-described space is prevented from excessively increasing. When the housing 103 is filled with the helium gas, the air in the above-described space is removable via the hollow portion 15.

The hydrogen gas other than the helium gas may be used as the gas filled inside the housing 103. Also, mixed gas of the helium gas and the hydrogen gas may be used, and mixed gas of one of the helium gas, the hydrogen gas, and the above-described mixed gas and the air may be used.

During assembly of the motor 1, the adhesive 7 may be applied to the outside surface of the shaft 10, and may be applied to both the outside surface of the shaft 10 and the inside surface of the recess portion 401. That is, the adhesive 7 is applied to the outside surface of the shaft 10 or the inside surface of the recess portion 401.

The adhesive 7 is the thermosetting adhesive. In particular, since the adhesive 7 is an epoxy-based thermosetting adhesive, the shaft 10 and the base portion 40 are fixed with high fastening strength as compared with the one having only anaerobic properties or the one having only ultraviolet curing properties. In the motor 1, the various adhesives having the anaerobic properties and the ultraviolet curing properties may be used as long as each of the adhesives has at least thermosetting properties.

The present disclosure is applicable to a motor and a disk drive, for example.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1. A motor for a disk drive, the motor comprising:
a stationary unit;
a bearing mechanism attached to the stationary unit; and
a rotation unit supported on the stationary unit rotatably around a central axis via the bearing mechanism; wherein
the stationary unit includes a base portion;
the base portion is a portion of a housing defining an internal space sealed in the disk drive and includes a recess portion that is recessed from a side of the internal space toward an outside of the housing and that is not penetrated;
the bearing mechanism includes a shaft extending in a direction of the central axis and a sleeve surrounding at least a portion of an outer circumferential surface of the shaft;
the shaft has a cylindrical shape including a hollow portion extending along the central axis;
an inner circumferential surface of the shaft includes a shaft step portion that extends directly radially outward from the central axis, the shaft step portion being provided at an axially upper end of the hollow portion;
a fixed step portion is provided at an axially lower side of the shaft step portion, the fixed step portion extending directly radially outward from the central axis;
a lower end portion of the shaft is press-fit and glued into the recess portion; and
a lower surface of the base portion includes a base step portion extending toward an axially upper side of the motor.

2. The motor according to claim 1, wherein the base step portion is located axially lower than the lower end portion of the shaft.

3. The motor according to claim 1, wherein the base step portion is located radially outward from a radially outer end of the rotation unit.

4. The motor according to claim 1, wherein
the stationary unit includes a stator unit fixed to the base portion and a wiring extending from a coil of the stator unit; and
the wiring extends along a surface of the base portion on a side of the internal space.

5. (canceled)

6. The motor according to claim 1, further comprising an insertion hole that penetrates radially outside from the inner circumferential surface of the shaft toward the outer circumferential surface at an axially lower side of the hollow portion.

7. A disk drive comprising:
the motor according to claim 1;
a disk supported by the rotation unit in the internal space of the housing; and
an access unit to perform at least one of reading of information and writing to the disk; wherein
the internal space is filled with a gas having a density lower than air.

8. A motor for a disk drive, the motor comprising:
a stationary unit;
a bearing mechanism attached to the stationary unit; and
a rotation unit supported on the stationary unit rotatably around a central axis via the bearing mechanism; wherein
the stationary unit includes a base portion;
the base portion is a portion of a housing defining an internal space sealed in the disk drive and includes a recess portion that is dented from a side of the internal space toward an outside of the housing and that is not penetrated;
the bearing mechanism includes a shaft extending in a direction of the central axis and a sleeve surrounding at least a portion of an outer circumferential surface of the shaft;
a lower end portion of the shaft is fixed into the recess portion by press-fitting and gluing;
a lower surface of the base portion includes a base step portion dented towards an axially upper side of the motor; and
the base step portion is located radially outward from a radially outer end of the rotation unit.

9. The motor according to claim 8, wherein the base step portion is located axially lower than the lower end portion of the shaft.

10. The motor according to claim 8, wherein
the stationary unit includes a stator unit fixed to the base portion and wiring extending from a coil of the stator unit; and
the wiring is extends along a surface or the base portion on a side of the internal space.

11. The motor according to claim 8, wherein
the shaft has a cylindrical shape including a hollow portion extending along the central axis; and
an inner circumferential surface of the shaft includes a shaft step portion that extends radially outward from the central axis at an axially upper side of the hollow portion.

12. The motor according to claim 11, further comprising an insertion hole that penetrates radially outside from the inner circumferential surface of the shaft toward the outer circumferential surface at an axially lower side of the hollow portion.

13. A disk drive comprising:
the motor according to claim 8;
a disk supported by the rotation unit in the internal space of the housing; and
an access unit to perform at least one of reading of information and writing to the disk; wherein
the internal space is filled with a gas having a density lower than air.
